(19) United States
(12) Patent Application Publication
(10) Pub. No.: US 2021/0308602 A1
(43) Pub. Date: Oct. 7, 2021

(54) Wedge Wire Filter Tubes with Narrowed Slots

(71) Applicant: Trislot NV, Waregem (BE)

(72) Inventor: Koen De Bock, Kortrijk (BE)

(21) Appl. No.: 16/972,939

(22) PCT Filed: Jun. 8, 2018
(86) PCT No.: PCT/IB2018/000735

§ 371 Date: Dec. 7, 2020

(51) Int. Cl. B01D 29/11; B01D 29/48; B01D 39/12

(52) U.S. Cl. CPC B01D 29/111; B01D 39/12; B01D 29/48

(57) ABSTRACT

The invention provides novel slot tube screen material for filtering applications, in particular for separating solid particles from liquids. The slot tube filter screens manufactured according to the invention feature very small slot openings, which are narrowed with respect to a slot opening dimension of conventionally fabricated slot filter tubes. The slot tube construction of the invention comprises a torsion-rotation deformed structure of normally axially orientated parallel support members of the slot tube mantle, which further comprises spiral windings of profile wire around said support members, whereby at each contact crossing a solid weld connection fixes a crossing profile wire to a support member. The plastically twisted slot tube structure displays a helical distortion of the axial support ribs inside the slot tube. As a consequence the filter slot openings between adjoining windings of profile wire are markedly narrowed (versus undeformed slot tube), which offers the possibility of reliably achieving very small filter slot openings of less than 0.020 mm in slot tube filters or screens.

The present invention relates to filter devices for the separation of solid particulate materials from liquid streams, which are widely used in several technical fields and industrial sectors such as water purification treatment, chemical and petrochemical production and processing, food industries etc., including pressure filtration as applied in dewatering of slurries and in the removal of fine particles and impurities from thick and viscous liquids.

Suitable filtration materials and structures therefor are often of the type filter grids or screens and wire filter tubes, which are obtainable by securing together support members and closely spaced profile wires, thereby forming filter slots or interstices delimitated by adjacent profile wire elements. The known filter structures mentioned are clearly illustrated in the product leaflet of present applicant TRISLOT, see for instance the Trislot-document “Turning bright ideas into perfect screens” with date of 24 Oct. 2013.

The invention concerns more in particular prismatic, preferably almost perfectly cylindrical or tubular filter constructions of the type wire filter tube (cf. “slot tube”), which may be shaped by providing a supporting construction of axially parallel, longitudinal profile members spaced-apart and arranged along peripheral circle positions of filter tube section; around said support member arrangement there is spirally wound a profiled wire of desired cross-section and diameter and at each crossing of said enveloping wire with a supporting profile member it is firmly attached thereto, typically and preferably by a weld connection, such as by electrical welding (spot-welding) or by laser welding.

This well-known manufacturing method is described int. al. in patent document U.S. Pat. No. 5,705,069 with date of Jun. 1, 1998, see in particular FIG. 8; said patent furthermore illustrates filter devices for centrifugal water treatment that are equipped with screen baskets having filtration walls constituted by wedge wire slot tube filter material.

The gaps or slots between adjoining consecutive (profiled) wire windings are kept constant in width in the length direction of the filter slot tube by helical coiling of screen wire with uniform pace around the supporting profile members.

The slot opening dimension is determining for the separating performance of the filter tube or screen cylinder, and is primarily defined by the geometrical parameters of the spiral wire winding or its helical line (pitch, pace . . . ), and is further dependent on the profile type or cross-section of the wire windings.

Although in principle any suitable wire profile shape can be used (round, square, rectangular, etc.), it is more customary to employ wires of a trapezoid shape, or wires having a wedge-shaped or triangular cross-section, and preferably comprising a rounded upper angle portion (for easier welding contact with support member).

With above mentioned profile wires the filtration gaps over the entire surface of the wire filter tube can be provided, on one side of the filter tube, with a wedge-shape geometry which is favourable in filtration practice by lowering flow resistance of the filter surface, and which improves the efficiency of the filter tube device, by slowing down clogging of the filtration gaps and by enabling quick backflushing/washing or clean rinsing of obstructed filter slots.

It is an object of the present invention to provide for the need of slot filter tubes which are moreover capable of separating off in an effective manner also fine to very fine particles in liquid media.

Indeed, considering the present state of the art of manufacturing slot filter tubes it remains technically difficult for a desired filter slot width of markedly below 40 micro-m (0.040 mm), more in particular for filtering gaps of 0,020 mm in width and smaller, to achieve a slot tube filter product that is still of sufficient quality by using tight spiral winding and resistance spot-welding; as a matter of fact the quality requirement of uniformly even filter openings and the provision of a sufficiently large filtration capacities pose serious technical problems, and furthermore the productivity of fine slot tube fabrication itself becomes problematic.

For these reasons the separation of fine and very fine particulate solids from liquids is often carried out by using filter slot tubes in combination with filtration gauzes, or small-mesh screen cloth is applied in combination with differing filtration methods. However, said combination processes appear to be seldom satisfactory as full-valued alternatives for pure slot tube filtering methods, given that said combined filter systems give more often rise to technical problems, resp. are less efficient and as a result lead to less economical liquid/solid separations.

Above-mentioned limitations, disadvantages and problems in using state of the art devices are solved in a most effective way by applying a novel fabrication method according to the invention inclusive the use of the thereby obtained filter slot tube of the invention, which is defined in the appended claims and described into more detail and clarified hereinbelow.

In the most general sense and in its broadest scope the method according to the invention essentially consists in that a cylindrical or prismatic slot tube grid structure constituted by axially extending support profiles fastened together radially across by profiled wire elements, whereby adjoining radial profile wire elements define a continuous interstitial slot opening, i.e. a filtering gap of predetermined desired width, is subjected to circumferential rotational twist or torioning until a given amount of permanent plastic torsion deformation is attained, as recited in main independent claim 1.

The so obtained slot tube structure according to the invention is characterized by a spiral repositioning of the support profiles following a helical line away from the original axially orientated parallel position of the support profiles on the cylindrical or prismatic mantle of the slot tube, and further by a narrowing of the grid/screen slot openings between adjacent consecutive wire profile elements, as compared to the original slot opening prior to a rotational twist step, see the features recited in main claim 2.

The expression “fastened together radially across” may encompass different attachments or kinds of solid connections between the axial support profiles and the crossing radial profile wires. Most convenient is a weld connection obtainable by electrical resistance welding or by laser welding. But otherwise there is also the possibility of using a mechanical coupling or even an adhesive connection in order to solidly secure each crossing between support profile and profile wire. Among mechanical couplings there are for instance e.g. pin and eye connections, knot or loop attachments and the like.

Conventional and most common types of slot tube screens have a cylindrical shape with round cross-section, which preferably is a perfect circle, but round and polygonal sections approaching a circular shape also belong to the realm of the invention.

Indeed, the concept of the present invention is equally applicable to prismatic tube sections, whereby axially extending parallel support profiles, considered in cross-section, are located on the angular points of a preferably regular polygon.

The radially crossing profile wires may also comprise distinct annular wire elements which are equally distanced, arranged parallel to one another and secured to the supporting profiles.

It is however preferred that the profile wire follows an uninterrupted path and is continuously wound by a non-stop process in a spiral fashion around and up axial supporting profile members, whereby at each contact crossing the profile wire and supporting profile are firmly attached to one another, preferably by a weld connection.

According to a preferred embodiment of carrying out the invention the supporting profiles are disposed in an axial-symmetric way and parallel to one another as peripheral mantle lines of a cylindrical tube with a circular cross-section of desired diameter, and the continuous profile wire is helically coiled around the support profiles, whereby the non-stop running wire is permanently fixed thereto at each crossing by means of a spot-welding connection. In this helical winding and assembling process by spot-welding a predetermined initial slot opening width is established between mutually adjoining profile wires, whereby the characterizing feature of the invention consists in the fact that the required final slot opening is realized by subjecting the slotted tubular screen or filter body to plastic torsion in the axial direction of the slotted screen tube.

A suitable method for carrying out the key feature of the invention may comprise immobilizing one outer end portion of the cylindrical slot tube body, and consequently connecting the opposed tubular end portion with an adapted claw or clutch of a torque motor and thereby driving the latter end portion into rotational twisting until the cylinder body undergoes a permanent plastic torsion deformation. As a result the original axial-parallel orientation of the supporting profiles of the peripheral cylinder mantle of the slot tube is tuned into a twisted path following a helical line; depending on the number of imposed torsional rotations said helical path will adopt a varying angle towards the axial direction of the slot filter tube.

Owing to the fact that the solid weld connections are undeformable and hence will stay co-determinating for an axial interdistance between adjoining profile wires, it is consequently obvious that the oblique stretch deformation of the filter tube mantle's support profiles under the effect of torsional rotation, whereby the number of rotational twists determines the final oblique position of the helical path of the support profiles, will give rise to a proportional decrease or narrowing of the resulting slot width between adjacent profile wires.

This implies that the invention enables to adjust in a controlled way a slot width of a filter slot tube, incl. controlled narrowing the same.

As a consequence the invention allows to decrease the filter slot opening of filter slot screen tubes, which are known per se, to such an extent that the resulting slot tubes become suitable for filtering separations of much finer particles than formerly possible with state of the art devices.

Other preferred embodiments of carrying out the method according to the invention, and furthermore slot tube grid/screen components and slot tube filter elements as preferential products embodied by the present invention are defined in one or more subordinate claims depending from main claims 1 and 2.

A deeper understanding of the essence of the invention and further peculiar details and advantages of the invention will become more apparent from the following description of a preferred exemplary embodiment of the invention, which is illustrated and elucidated by the figures of drawing sheet 1/1.

The lower drawings A and C shown in the figure columns 1A and 1C on sheet 1/1 give a perspective view resp. overall picture of a slot tube filter screen of circular cross-section. Tubular filter screen C as well as A is assembled from supporting profile rods with axial-symmetric disposition, located at circumference of above-mentioned circular cross-section, which is clearly shown in sectional views A-A en C-C in the center part of figure columns 1 A and 1C of sheet 1/1.

De external mantle of filter tube A and filter tube C consists of profile wire with wedge-shaped cross-section, which is helically wound up and around the axially arranged support profiles and at each crossing is firmly secured by a welding connection.

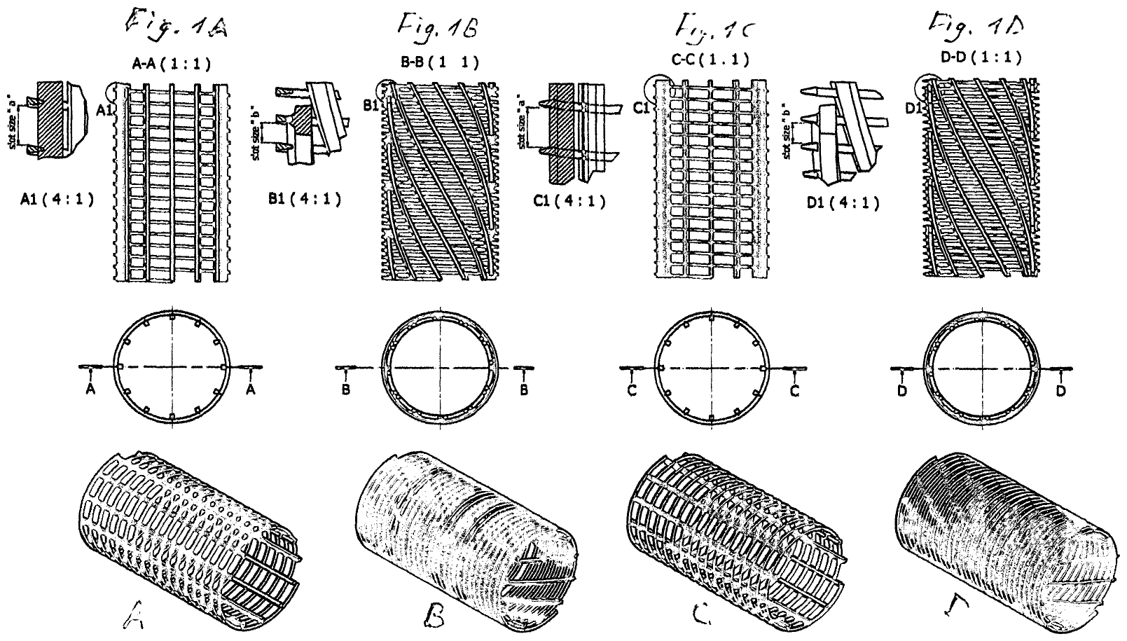

FIG. 1A illustrates a slot tube A wherein a flat side of the wedge profile wire is directed to the tube outside (with rounded top angle of wedge section spot-weld attached upon the supporting profile rods), such that interstitial filter slot openings between adjoining profile wire windings are widening in a flow direction from outside to inside the slot filter tube.

The slot filter tube C example of FIG. 1C shows the opposite situation: here a flat lower side of the wedge profile wire is weld-connected to the support profile rods, and adjacent wedge profile wire windings delimit interstitial filter slots that are widening in a flow direction from inside to outside the slotted filter tube.

The picture A-A with detail A1 and picture C-C with detail C1 in the upper part of FIGS. (columns) 1A and 1B on sheet 1/1 show an axial longitudinal section van filter tube A resp. filter tube C, whereby detailed close-up sections A1 en C1 clarify an initial filter slot opening of width “a” before subjecting slot filter tube A as well as slot filter tube C to permanent torsion deformation by rotary torsioning.

Figures B1 and D1 showing longitudinal section views B-B, D-D, with details B1, D1 and further depicting overall perspective views of slot tubes B en D illustrated in the lower drawing row on sheet 1/1, elucidate more clearly which technical effect the invention is exerting, as a consequence of imposed torsional rotations, on a resulting slot opening width “b” of a slot filter tube and on the external aspect view of the tubular filter body exhibiting a helical twist of its internally arranged supporting profiles.

It is self evident that the present invention is not limited to the exemplary embodiments of slot tubes described herein above and illustrated on drawing sheet 1/1.

Flat filter screen elements having narrowed slot openings can be manufactured in a similar but deduced way, e.g. starting from tubular slit screens provided with narrowed slot openings obtained by torsional rotation, and axial cutting/opening the tubular body and flattening out the developed slot tube jacket mantle.

Curved and flat screen or grating elements having narrowed slot openings obtained by applying the key principle of the invention, including their working up and use in filter devices and systems also fall within the scope of protection of the present invention, which is primarily defined by the technical features recited in the appended claims.

The material used for fabricating slot tube filters for the purpose of solid/liquid filtering separations is mostly selected from stainless steels of a type suitable for withstanding the corrosivity of the liquid medium, and/or requires a particular stainless steel grade satisfying specific use conditions (hygienic, toxicity, etc.) imposed by the related industrial sector, such as for instance the food industries.

It is however obvious that the inventive concept of the present invention is not restricted to the normally used stainless steel alloys, but is equally applicable to other metals and metal alloys such as copper, nickel, aluminium and alloys thereof, as for instance monel (CuNi) and also titanium, special metal alloys as superalloys etc., provided said corrosion resistant metals and alloys can be worked up to profile wire and the like profile members, and are moreover mutually connectable by welding.

1. Method of fabricating a slot tube, in particular a slot tube (screen) filter, which enables controlled attuning of a desired fine filter slot opening, whereby use is made of a conventionally known slot tube assembly of interconnected basic elements, which consist of axially extending support profiles wrapped around with radially crossing wire windings of profile wire, which are solidly fixed together at each mutual crossing and whereby adjoining profile wire windings delimit and define an interstitial, continuous (filter-) slot opening, characterized in that said known slot tube is subjected to torsion deformation by rotary twist, whereby the slot tube mantle is twisted relative to the slot tube axis by an adjustable amount of rotations within the plastic torsion area causing a permanent twist of the axial support ribs, and this until a desired final slot opening width or a required narrowing of initial (filter) slot opening is reached.

2. Slot tube or slot tube filter directly obtained by the method of claim 1, wherein an original disposition of parallel, axially directed support or mantle profiles of said known slot tube displays a torsion deformation pattern of support profiles following helical lines, and this in combination with a narrowed slot opening between adjacent wrappings of profile wire, as depicted in FIGS. 1A to 1D.

3. Slot tube as defined in claim 2, characterized in that the narrowed slot opening is smaller than 0.040 mm, in particular smaller than 0.020 mm.

4. Slot tube according to claim 2 or 3, wherein profile wire is helically wound with given pace and pitch parameter around axially directed support profile ribs, and wherein at each crossing a solid connection between support ribs and profile wire is selected from a weld connection, a mechanical fixation or an adhesive bonding, and preferably comprises a metallurgical weld connection obtained by electrical resistance welding such as spot-welding or obtained by laser welding.

5. Slot tube as defined in one of claims 2 to 4, wherein the profile wire comprises a cross-section selected from a round, a flat or a polygonal cross-section, and preferably comprises a wedge-shaped, trapezoid- or triangular-shaped section.

6. Slot tube according to one of claims 2 to 5, wherein the slot tube body has a cross-section selected from a circular section, a round section of oval shape or nearby circular form, a regular polygon or rounded polygon approaching a circle and the like, and preferably comprises the circumference of a perfect circle.

7. Slot tube according to one of claims 2 to 6, characterized in that the profile wire comprises a wedge-shaped or triangular cross-section with rounded top angle, and whereby either the flat side or the rounded top of the wedge or triangular wire forms a solid weld connection with the supporting profile members, such that the interstitial slot opening between adjoining profile wires can be disposed as a widening gap or a narrowing (wedge) opening in a selected flow direction.

8. Flat grid/screen filter elements having a narrowed filter slot opening obtained by applying the method according to claim 1 or by using a slot tube as defined in claim 2, characterized in that the torsion-twisted slot tube is cut open in a longitudinal direction, developed into a plane and flattened to flat grid/screen filter panels.
